(19) United States
(12) Patent Application Publication
(10) Pub. No.: US 2018/0082614 A1
(43) Pub. Date: Mar. 22, 2018

(54) DISPLAY SUBSTRATE, MANUFACTURING METHOD THEREOF AND DISPLAY DEVICE

(71) Applicants: BOE TECHNOLOGY GROUP CO,. LTD., BEIJING (CN); BEIJING BOE OPOELECTRONICS TECHNOLOGY CO,. LTD., BEIJING (CN)

(72) Inventors: Yang YOU, (US); Kaixuan Wang, Beijing (CN); Yue Li, Beijing (CN); Li MA, (US); Xiaoqing Peng, Beijing (CN); Huishun Chen, Beijing (CN); Zijing Zhang, Beijing (CN); Dong Liang, Beijing (CN); QI Zheng, Beijing (CN); Yao BI, Beijing (CN); Xiaojuan WU, Beijing (CN); Hongliang Yuan, Beijing (CN)

(21) Appl. No.: 15/555,211

(22) PCT Filed: Jan. 18, 2017
(86) PCT No.: PCT/CN2017/071555

§ 371 Date: Sep. 1, 2017

(30) Foreign Application Priority Data
May 11, 2016 (CN) 201610309802.X

(51) Int. Cl. G09F 9/30; F21V 31/00; F21V 9/08; B23P 19/04

(52) U.S. Cl. CPC G09F 9/30; B23P 19/04; F21V 9/08; F21V 31/005

(57) ABSTRACT

A display substrate, a manufacturing method thereof, and a display device are disclosed. The display substrate includes a display region and a peripheral region encircling the display region. A sealant is disposed in the peripheral region and includes at least one corner. The display substrate further includes at least one retaining wall disposed at the at least one corner of the sealant; the at least one retaining wall is disposed in one-to-one correspondence with the at least one corner of the sealant and is located on one side of the sealant facing the display region. The retaining wall has an integral structure.

### TECHNICAL FIELD

Embodiments of the present disclosure relate to a display substrate, a manufacturing method thereof and a display device.

### BACKGROUND

Narrow bezel has always been a technology that terminal manufacturers are of great interests, and is also a target that panel manufacturers have always been committed to pursue.

### SUMMARY

An embodiment of the present disclosure provides a display substrate, including a display region and a peripheral region encircling the display region. A sealant is disposed in the peripheral region and includes at least one corner. The display substrate further includes at least one retaining wall disposed at the at least one corner of the sealant; the at least one retaining wall is disposed in one-to-one correspondence with the at least one corner of the sealant and is located on one side of the sealant facing the display region. The retaining wall has an integral structure.

In the display substrate, the retaining wall is configured to prevent a material of the sealant from passing through the retaining wall.

In one example, the retaining wall has a uniform height in a direction perpendicular to the display substrate.

In one example, in a direction perpendicular to the display substrate, a minimum height of the retaining wall is greater than or equal to a maximum height of the sealant at the corner closest to the retaining wall.

In one example, the retaining wall has a same material with that of at least one type of color filter (CF) in the display region.

In one example, both the retaining wall and the corner of the sealant closest to the retaining wall are formed to be protruding away from the display region.

In one example, the retaining wall and the corner of the sealant closest to the retaining wall have a same bending degree.

In one example, the display substrate is a CF substrate.

In one example, the display substrate is a Color Filter on Array (COA) substrate.

In one example, in a plan view of the display substrate, the retaining wall is extended to exceed extension lines of two intersected edges of the display region.

Another embodiment of the present disclosure provides a manufacturing method of display substrate. The display substrate includes a display region and a peripheral region encircling the display region. The manufacturing method includes: forming a sealant in the peripheral region, wherein the sealant includes at least one corner. The manufacturing method further includes: forming at least one retaining wall at the at least one corner of the sealant, wherein the at least one retaining wall is disposed in one-to-one correspondence with the at least one corner of the sealant and is located on one side of the sealant facing the display region, and wherein the retaining wall has an integral structure.

In one example, the retaining wall is structured to prevent a material of the sealant from passing through the retaining wall.

In one example, the retaining wall has a uniform height in a direction perpendicular to the display substrate.

In one example, in a direction perpendicular to the display substrate, a minimum height of the retaining wall is greater than or equal to a maximum height of the sealant at the corner closest to the retaining wall.

In one example, the retaining wall is formed along with at least one type of color filter (CF) in the display region.

In one example, both the retaining wall and the corner of the sealant closest to the retaining wall are formed to be protruding away from the display region.

In one example, the retaining wall and the corner of the sealant closest to the retaining wall have a same bending degree.

In one example, in a plan view of the display substrate, the retaining wall is extended to exceed extension lines of two intersected edges of the display region.

Still another embodiment of the present disclosure provides a display device including any of the above display substrates.

### BRIEF DESCRIPTION OF THE DRAWINGS

Hereafter, the embodiments of the present disclosure will be described in a more detailed way with reference to the accompanying drawings, so as make one person skilled in the art be able to understand the present disclosure more clearly, wherein:

FIG. 1 is a schematic plan view illustrating a display substrate;

FIG. 2 is a schematic sectional view of a barrier in FIG. 1;

FIG. 3 is a schematic plan view illustrating a display substrate provided by a first embodiment of the present disclosure;

FIG. 4 is a schematic plan view illustrating a portion of a retaining wall in FIG. 3; and

FIG. 5 is a schematic sectional view taken along A-A′ line of FIG. 4.

### REFERENCE NUMERALS

1-display region; 2-peripheral region; 3-sealant; 4-barrier; 41-blocking column; 5-retaining wall.

### DETAILED DESCRIPTION

Hereafter, the technical solutions in the embodiments of the present disclosure will be described in a clearly and fully understandable way in connection with the drawings in the embodiments of the present disclosure. It is obvious that the described embodiments are just a part but not all of the embodiments of the disclosure. Based on the described embodiments herein, one person skilled in the art can obtain other embodiment(s), without any inventive work, which should be within the scope of the disclosure.

Unless otherwise defined, the technical terminology or scientific terminology used herein should have the same meaning as commonly understood by one of ordinary skill in the art to which this invention belongs. Likewise, terms like “first,” “second.” etc., which are used in the description and the claims of the present application for invention, are not intended to indicate any sequence, amount or importance, but distinguish various components. The phrases “connect”, “connected”, etc., are not intended to define a physical connection or mechanical connection, but may include an electrical connection, directly or indirectly. “On,” “under,” “left,” “right” or the like is only used to describe a relative positional relationship, and when the absolute position of a described object is changed, the relative positional relationship might also be changed accordingly.

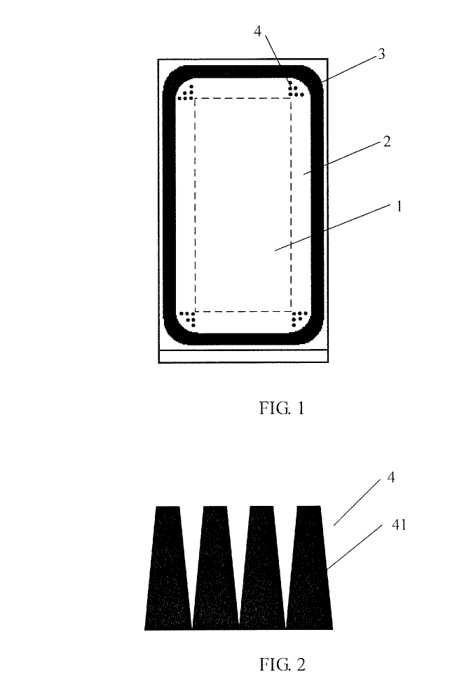

Narrow-bezel design poses more challenges to the product yield in addition to the consideration of the arrangement and the thinning of transistors. As illustrated in FIG. 1 and FIG. 2, for instance, after coating a sealant 3, the sealant 3 at four corners of a peripheral region 2 of a display panel is relatively sloppy. As the product has narrow bezel, the sloppy sealant 3 may easily be contacted with a display region 1 (AA area) of the display panel. Even not contacted, precipitates of the sealant 3 will also easily move into the display region 1. At this point, a failure due to light leakage may occur, and such failure is common in actual products.

For instance, multiple blocking columns 41, that are simultaneously formed with spacers and have a same shape with the spacers, are closely arranged to form barriers 4 which are disposed at the four corners of the sealant 3, so as to prevent the precipitates of the sealant 3 from polluting the display region 1 of the display panel. As the overall shape of each blocking column 41 in the barrier 4 is wedge, gaps may be generated between upper portions of the blocking columns 41; as a result, the sealant 3 still will be precipitated from the gaps, resulting in light leakage at the corners.

Embodiments of the present disclosure provide a display substrate, a manufacturing method thereof and a display device which are capable of effectively preventing a material of sealant from polluting a display region, so as to avoid light leakage.

### THE FIRST EMBODIMENT

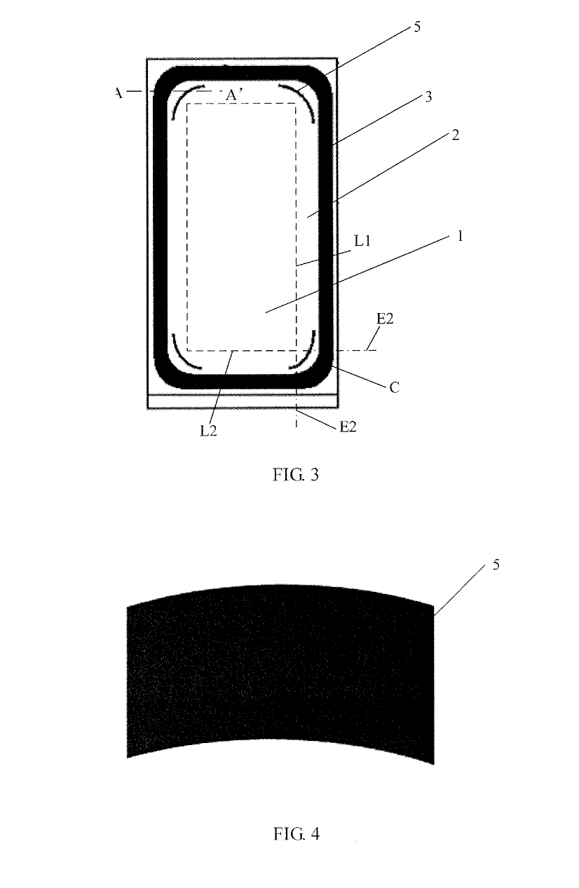

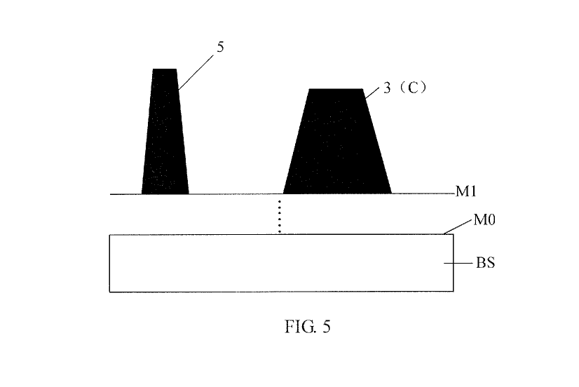

With reference to FIG. 4 and FIG. 5, the present embodiment provides a display substrate including a display region 1 and a peripheral region 2 encircling the display region 1. A sealant 3 is disposed in the peripheral region 2. The display substrate further includes a retaining wall 5 disposed at a corner C of the sealant 3, close to the display region 1; and the retaining wall 5 has an integral structure. Herein, the corner C of the sealant 3 indicates a bent portion for connecting two adjacent flat portions of the sealant.

It should be noted herein that: the integral structure of the retaining wall 5, for instance, refers to a complete structure, in which there is no gap allowing the material of the sealant to pass there-through. The integral structure may be constituted by splicing several patterns; and at spliced positions, there is no gap which allows the material of the sealant to pass there-through.

In the display substrate provided by the embodiment, the retaining wall 5 with integral structure is adopted as the retaining wall 5 at the corner of the sealant 3, so as to well prevent precipitate at the corner of the sealant 3 from polluting the display region 1 of the display substrate. Meanwhile, the sealant 3 will not overflow from the retaining wall 5, either, so the problem of light leakage at the corner of the sealant 3 can be effectively solved.

For instance, as illustrated in FIG. 3, the retaining wall 5 is formed at respective (four) corners of the sealant 3, close to the display region 1. In this way, the precipitate at the corners of the sealant 3 can be prevented from polluting the display region 1 of the display substrate from various directions. Meanwhile, the sealant 3 will not overflow from the retaining walls 5, either, so the problem of light leakage at the corners of the sealant 3 can be effectively solved.

For instance, a bending direction and a bending degree of the retaining wall 5 are the same with a bending direction and a bending degree of the corner C of the sealant 3 corresponding to the retaining wall. Herein, the corner of the sealant 3 corresponding to the retaining wall 5 refers to the corner of the sealant 3 closest to the retaining wall 5. The bending direction of the retaining wall 5 and the bending direction of the corner of the sealant 3 corresponding to the retaining wall, for instance, refer to that both the retaining wall 5 and the corner C of the sealant 3 corresponding to the retaining wall are protruded away from the display region 1. That is to say, the retaining wall 5 is matched with the corner corresponding thereto. This not only can effectively prevent the precipitate of the sealant 3 from polluting the display region 1 but also can reduce the width of the occupied peripheral region 2, and hence can achieve narrow-bezel design.

In one example, all portions of the retaining wall 5 have basically the same height H; and all portions of the corner C of the sealant 3 corresponding to the retaining wall 5 also have basically the same height h. FIG. 5 is a schematic sectional view taken along A-A′ line of FIG. 4. The height herein is defined relative to a same plane parallel to a principal plane of the display substrate. This plane may be an actual surface and may also be a virtual surface. The principal plane of the display substrate, for instance, refers to an upper surface M0 of a base substrate BS. Multiple pixel structures are formed on the upper surface M0 of the base substrate BS.

As illustrated in FIG. 5, in a direction perpendicular to the display substrate, for instance, in the direction perpendicular to the upper surface M0 of the base substrate BS, the height of the retaining wall 5 relative to a plane M1 is H; the height of the corner C of the sealant 3 corresponding to the retaining wall 5, relative to the plane M1, is h; and H is greater than h. In another example, for instance, H is equal to h.

In another example, portions of the retaining wall 5 have different heights; and portions of the corner C of the sealant 3 corresponding to the retaining wall 5 also have different heights. In this case, a minimum height of the retaining wall 5 is greater than or equal to a maximum height of the corner C of the sealant 3 corresponding to the retaining wall 5.

In one example, as illustrated in FIG. 3, the display region 1 of the display substrate has a rectangular shape. Two edges L1 and L2 of the display region respectively have extension lines E1 and E2. The retaining wall 5 at the lower right corner as illustrated in FIG. 3 is extended to exceed the extension lines E1 and E2.

For instance, the retaining wall 5 in the display substrate and at least one kind of color filter (CF) in the display region 1 are made from a same material.

For instance, supposing that the display substrate includes red CFs, green CFs and blue CFs, then the retaining wall 5 may have a same material with any one of the red CF, the green CF and the blue CF. That is to say, the retaining wall 5 may be formed along with any one of the red CF, the green CF and the blue CF. Therefore, the retaining wall 5 in the embodiment does not require a separate patterning process, and hence saves the cost. In general, a thickness of the CF of each color is about 2.2 μm. if the thickness cannot satisfy the requirement that the retaining wall 5 can prevent the precipitate of the sealant from polluting the display region 1, namely the thickness of 2.2 μm is less than the thickness required by the retaining wall 5, then the retaining wall 5 may be formed as a superposed structure constituted by CFs of multiple colors. That is to say, the retaining wall 5 may have a same material with multiple CFs among the red CFs, the green CFs and the blue CFs; namely the retaining wall 5 may be formed as a two-layered structure or a three-layered structure.

The display substrate may be a CF substrate and may also be a Color Filter on Array (COA) substrate. At this point, the retaining wall 5 in the display substrate may be formed along with at least one kind of CF in the display region 1 by a single patterning process, so as to save processing steps and reduce the cost.

In summary, as compared with the case of adopting a barrier constituted by multiple blocking columns formed along with spacers in the prior art, in the display substrate provided by the embodiment of the present disclosure, a retaining wall 5 with integral structure is adopted as the barrier, wherein the retaining wall has a height and a width with better stability and uniformity, and can effectively prevent the precipitate of the sealant 3 from polluting the display region 1 of the display substrate. Meanwhile, the sealant 3 will not overflow from the retaining wall 5, so as to effectively avoid light leakage at the corner of the sealant 3.

### THE SECOND EMBODIMENT

Another embodiment of the present disclosure provides a manufacturing method of display substrate. The display substrate may be those provided by the first embodiment. The manufacturing method of display substrate includes: forming retaining walls 5 at respective corners of the sealant 3 close to the display region 1, in which the retaining wall 5 has an integral structure.

For instance, the display substrate may be a CF substrate or a COA substrate. Detailed description will be given below to the manufacturing method of display substrate provided by the embodiment of the present disclosure with reference to the CF substrate by way of example.

The manufacturing method of the CF substrate may include: forming black matrixes (BMs) on a base substrate BS by processes such as coating, exposing, developing and roasting; and forming CFs in a display region 1 of the base substrate BS and forming retaining walls 5 in a peripheral region 2 of the base substrate BS, above the BMs, by processes such as coating, exposing, developing and roasting. Supposing that the CF substrate includes sub-pixels of three colors RGB, and then it includes CFs of the three colors RGB, in which the BMs and the CFs are spaced from each other.

In an example, a thickness of the BM is 1.2 μm, and a thickness of the CF of each color is 2.2 μm. If the thickness of 2.2 μm can satisfy the height requirement of the retaining wall 5, then the retaining wall 5 is formed along with any one of red CF, green CF and blue CF. That is to say, the retaining wall 5 has a single-layered structure. If the thickness of 2.2 μm cannot satisfy the height requirement of the retaining wall 5, then the retaining wall 5 is formed along with more than one of red CF, green CF and blue CF. That is to say, the retaining wall 5 is formed as a superposed structure constituted by CFs of multiple colors, such as a two-layered structure or a three-layered structure.

After the completion of the above steps, the sealant 3 is coated along an edge of the peripheral region 2 on the base substrate. Herein, the bending direction and the bending degree of the retaining wall 5 are the same with the bending direction and the bending degree of the corner of the sealant 3 corresponding to the retaining wall 5.

Of course, the manufacturing method of the CF substrate provided by the embodiment further includes the steps of forming spacers, forming an overcoat (OC) layer and forming an alignment layer. These steps all may be performed by using conventional methods in the prior art, with detailed description thereof omitted.

Similarly, when the display substrate is a COA substrate, display elements such as thin-film transistors (TFTs), gate lines and data lines need to be formed firstly on a base substrate; and then CFs and retaining walls 5 are formed by the foregoing steps of which the description will not be repeated herein.

In summary, in the manufacturing method of display substrate provided by the embodiment of the present disclosure, the retaining wall 5 as formed has an integral structure having a height and a width with better stability and uniformity, and hence can more effectively prevent the precipitate of the sealant 3 from polluting the display region 1 of the display substrate. Meanwhile, it can also effectively avoid light leakage at the corner of the sealant 3.

### THE THIRD EMBODIMENT

Yet another embodiment of the present disclosure provides a display device including any of the display substrates provided by foregoing embodiment. For instance, the display device may further include an opposed substrate disposed opposite to the display substrate.

Of course, the display device provided by the embodiment of the present disclosure may be any product or component with display function, such as a mobile phone, a tablet PC, a TV, a display, a notebook computer, a digital picture frame and a navigator.

The display device provided by the embodiment of the present disclosure, for instance, also includes structures such as an outer frame.

Obviously, various modifications and deformations can be made to the present disclosure by those skilled in the art without departing from the spirit and scope of the present disclosure. Therefore, the present disclosure is intended to include the modifications and deformations fallen within the scope of the appended claims and equivalents thereof.

The present application claims the benefits of Chinese patent application No. 201610309802. X filed with the SIPO on May 11, 2016, which is incorporated herein by reference as part of the application.

1. A display substrate, comprising: a display region and a peripheral region encircling the display region, wherein a sealant is disposed in the peripheral region and includes at least one corner,
the display substrate further comprises at least one retaining wall disposed at the at least one corner of the sealant; wherein the at least one retaining wall is disposed in one-to-one correspondence with the at least one corner of the sealant and is located on one side of the sealant facing the display region; and wherein the retaining wall has an integral structure.

2. The display substrate according to claim 1, wherein the retaining wall is configured to prevent a material of the sealant from passing through the retaining wall.

3. The display substrate according to claim 1, wherein the retaining wall has a uniform height in a direction perpendicular to the display substrate.

4. The display substrate according to claim 1, wherein in a direction perpendicular to the display substrate, a minimum height of the retaining wall is greater than or equal to a maximum height of the sealant at the corner closest to the retaining wall,

5. The display substrate according to claim 1, wherein the retaining wall has a same material with that of at least one type of color filter (CF) in the display region.

6. The display substrate according to claim 1, wherein both the retaining wall and the corner of the sealant closest to the retaining wall are formed to be protruding away from the display region.

7. The display substrate according to claim 6, wherein the retaining wall and the corner of the sealant closest to the retaining wall have a same bending degree.

8. The display substrate according to claim 1, wherein the display substrate is a CF substrate.

9. The display substrate according to claim 1, wherein the display substrate is a Color Filter on Array (COA) substrate.

10. The display substrate according to claim 1, wherein in a plan view of the display substrate, the retaining wall is extended to exceed extension lines of two intersected edges of the display region.

11. A manufacturing method of display substrate, the display substrate comprising a display region and a peripheral region encircling the display region,
the manufacturing method comprising: forming a sealant in the peripheral region, wherein the sealant comprises at least one corner;
the manufacturing method further comprises: forming at least one retaining wall at the at least one corner of the sealant,
wherein the at least one retaining wall is disposed in one-to-one correspondence with the at least one corner of the sealant and is located on one side of the sealant facing the display region, and wherein the retaining wall has an integral structure.

12. The manufacturing method of display substrate according to claim 11, wherein the retaining wall is structured to prevent a material of the sealant from passing through the retaining wall.

13. The manufacturing method of display substrate according to claim 11, wherein the retaining wall has a uniform height in a direction perpendicular to the display substrate.

14. The manufacturing method of display substrate according to claim 11, wherein in a direction perpendicular to the display substrate, a minimum height of the retaining wall is greater than or equal to a maximum height of the sealant at the corner closest to the retaining wall.

15. The manufacturing method of display substrate according to claim 11, wherein the retaining wall is formed along with at least one type of color filter (CF) in the display region.

16. The manufacturing method of display substrate according to claim 11, wherein both the retaining wall and the corner of the sealant closest to the retaining wall are formed to be protruding away from the display region.

17. The manufacturing method of display substrate according to claim 16, wherein the retaining wall and the corner of the sealant closest to the retaining wall have a same bending degree.

18. The manufacturing method of display substrate according to claim 11, wherein in a plan view of the display substrate, the retaining wall is extended to exceed extension lines of two intersected edges of the display region.

19. A display device, comprising a display substrate, the display substrate comprises; a display region and a peripheral region encircling the display region, wherein a sealant is disposed in the peripheral region and includes at least one corner,
the display substrate further comprises at least one retaining wall disposed at the at least one corner of the sealant; wherein the at least one retaining wall is disposed in one-to-one correspondence with the at least one corner of the sealant and is located on one side of the sealant facing the display region; and wherein the retaining wall has an integral structure.

20. The display device according to claim 19, wherein in a direction perpendicular to the display substrate, a minimum height of the retaining wall is greater than or equal to a maximum height of the sealant at the corner closest to the retaining wall.
